(19) United States
(12) Patent Application Publication
(10) Pub. No.: US 2012/0159567 A1
(43) Pub. Date: Jun. 21, 2012

(54) CONTEXTUAL ROLE AWARENESS

(75) Inventors: Andrew Jong Kein Toy, New York, NY (US); Alexander Allan Trewby, London (GB); David Wei Zhu, Palo Alto, CA (US)

(73) Assignee: ENTERPROID HK LTD, Hong Kong (CN)

(21) Appl. No.: 12/974,478

(22) Filed: Dec. 21, 2010

(51) Int. Cl. G06F 17/30; G06F 17/00; G06F 3/033; G06F 7/00; H04L 29/06

(52) U.S. Cl. 726/1; 707/705; 713/165; 715/863; 726/5; 707/802; 707/781

(57) ABSTRACT

The disclosed subject matter relates to an architecture that can provide contextual role awareness. For example, rather than focusing on features and functionality at the device level, features and functionality can be controlled based upon various roles that can be related to various personas of a user. Thus, in a business or enterprise setting, the enterprise can manage a business role in accordance with that enterprise's security objectives, which might dramatically limit certain features for the user. However, the user can quickly switch roles, away from the business role in order to again access desired features, yet without compromising the security objectives of the enterprise.

### TECHNICAL FIELD

The present application relates generally to contextual role awareness, and more specifically providing multiple contextual roles for a mobile operating system.

### BACKGROUND

Due to fundamental differences in design, mobile operating systems face a different set of security risks than do desktop-oriented operating systems. For example, a mobile operating system might provide access to contact information as part of a core service. Thus, any application can potentially have access to all of a user's contact information. Such is desirable in that two different contacts applications can access the same information, which can also be the same data accessed by a short message service (SMS) application. Therefore, applications can be created to give users any number of different views on the data, or provide different features or functionality with respect to those data, but the data leveraged for such can be common to all applications. In contrast, desktop-oriented operating systems typically combine application and data in a single monolithic construct. Accordingly, without intimate knowledge of one email application's structure (generally proprietary), a second email application cannot leverage the same data, but rather must use only its own set of data.

As a result, a typical risk scenario for users of mobile devices (with associated mobile operating systems) can be as follows. Consider a crime syndicate that produces a mobile application, say an entertaining, widely distributed, pinball game. On the surface, the pinball app appears benign, but in addition to the gaming features provided, the application also acts as a Trojan, making a call to an operating system-supported data provider to obtain the user's list of contact. Once acquired, these data are uploaded to the crime syndicate's servers, and thereafter used in connection with identity theft or the like.

In the mobile device domain, a wide variety of competition and approaches exists in the current market. However, mobile devices targeting the enterprise and/or corporate space is dominated by a single company, with an approach that allows a very high degree of security. For example, Research In Motion (RIMM), which markets Blackberry-brand mobile devices has a very large market share in the enterprise space, largely because Blackberry-brand devices provide hundreds of configurable policies that can be managed by a corporation. In contrast, market competitors such as iPhone-brand, or Windows-brand devices provide only a handful of configurable policies, while devices controlled by Android-based operating systems currently do not provide for any such policies.

In the enterprise domain, corporations can have liability for security breaches, and thus most corporations opt to use Blackberry-brand devices. In a typical scenario, a corporation will purchase the enterprise phone and the associated service for its employees. Hence, the corporation will assign the employee various addresses (e.g., “employee@company.com”) and bind the phone to that domain, upon which the hundreds of policies will be downloaded and applied to the device. Such policies can include settings for whitelists or blacklists for various networks or domains, whether applications can be installed, screenlock enforcement, as well as hundreds of other attributes that relate to available features or functionality of the device.

With regard to the above-mentioned risk scenario in which an identity theft syndicate publishes a Trojan pinball app, Blackberry-brand devices allow client enterprises to configure policies to prevent such a security breach. In particular, the enterprise can activate a setting that refuses to allow any application to be installed, and the device will enforce this policy as with all other policies. Unfortunately, the obvious trade-off is that in order to prevent the security risk, the enterprise must necessarily deny the user of features or functionality that would otherwise be available. For instance, in this example, the user is not only forbidden to run the pinball application, but potentially all other applications that are not pre-installed or not in some way authorized or allowed by the enterprise.

As another example, consider the case in which the enterprise manages the available policies to require a screenlock after 30 seconds of inactivity, and further requires a very secure password of at least 10 characters to be entered to bypass the screenlock. In the enterprise world, such can be a very reasonable requirement, yet for the employee, such can be inefficient if not annoying. For example, the employee who customarily calls his wife on the drive home every day after work must first enter a sophisticated passcode prior to dialing home, which can be troublesome for a number of obvious reasons. Again, it is readily apparent that security solutions provided for mobile devices often require an attendant compromise in either features or convenience.

In addition, the solution offered by Blackberry-brand devices, wherein literally hundreds of policies can be configured often leads to other undesirable situations. Namely, a single person, or small group of people, most likely associated with an IT department will be assigned the job of configuring the policies that will apply to all the enterprise devices carried by employees of the enterprise. Thus, IT personnel will often determine either the security objectives of the enterprise, or at least how those objectives will be implemented on the enterprise phones. Moreover, given the hundreds of policies that must be set, it is likely that many of the options will not be thoroughly understood. As a result, two common situations will arise. Either the IT personnel (or other personnel responsible for configuring the policies) will be overly conservative, which is most common, or, in rare cases, overly lax. In the former case, many features or functionality that might otherwise be available to the employees using the enterprise phones will be unnecessarily inaccessible. In the latter case, the enterprise can be unnecessarily exposed to additional security risks. In both cases, a less then optimal experience with respect to use of the enterprise phones will result.

Accordingly, there is a need to provide enterprises with robust security policies for enterprise phones or other mobile devices, without compromising features and functionality of the phone. Moreover, there is an additional need to mitigate the problems associated with configuring any such robust security policies. In particular, to mitigate degradation of the user experience when policies are set in an overly conservative manner.

### SUMMARY

The following presents a simplified summary of the disclosed subject matter in order to provide a basic understanding of some aspects of the disclosed subject matter. This summary is not an extensive overview of the disclosed subject matter. It is intended to neither identify key or critical elements of the disclosed subject matter nor delineate the scope of the disclosed subject matter. Its sole purpose is to present some concepts of the disclosed subject matter in a simplified form as a prelude to the more detailed description that is presented later.

The subject matter disclosed herein, in one aspect thereof, comprises an operating system architecture that can facilitate or provide contextual role awareness. In accordance therewith and to other related ends, the architecture can include a role engine that can be configured to manage multiple roles associated with multiple contextual personas. For example, the multiple roles can allow a business role, a personal role, a family role, a chess club role, a high risk role, and so forth. Moreover, the role engine can be further configured to determine a current role.

In addition, the architecture can also include at least one data provider configured to access core service data (e.g., contacts, addresses, call logs, message histories . . . ) from a selected database that is selected from amongst a set of databases based upon the current role determined by the role engine.

Accordingly, the role engine can facilitate, generally in response to a user command or gesture, a role switch between, say, the business role and the personal role. By employing the disclosed approach, the architecture can maintain various versions of core service data and also maintain policies associated with the multiple roles. Hence, various roles can be managed according to different sets of policies (as well as by different entities or identities), and data associated with the various roles can be distinct as well such that both restrictions and security risks in one role need not apply to other roles.

The following description and the annexed drawings set forth in detail certain illustrative aspects of the disclosed subject matter. These aspects are indicative, however, of but a few of the various ways in which the principles of the disclosed subject matter may be employed and the disclosed subject matter is intended to include all such aspects and their equivalents. Other advantages and distinguishing features of the disclosed subject matter will become apparent from the following detailed description of the disclosed subject matter when considered in conjunction with the drawings.

### BRIEF DESCRIPTION OF THE DRAWINGS

FIG. 1 is a block diagram of a system that can provide contextual role awareness.

FIG. 2 depicts a block diagram of an example mobile operating system and related layers.

FIG. 3 illustrates a block diagram of an example open source mobile operating system.

FIG. 4 is a block diagram of a system that can facilitate a role switch in connection with contextual role awareness.

FIG. 5 depicts a block diagram of a system that can apply and manage policies in connection with operating system-based contextual role awareness.

FIG. 6 illustrates a block diagram of a system that can provide multiple data stores for multiple contextual roles.

FIG. 7 is an exemplary flow chart of procedures that define a method for providing contextual role awareness for a mobile operating system associated with an electronic device.

FIG. 8 depicts an exemplary flow chart of procedures defining a method for providing additional features or aspects in connection with providing contextual role awareness.

FIG. 9 provides an exemplary flow chart of procedures defining a method for facilitating a role switch between two of the multiple contextual roles.

FIG. 10 illustrates an example wireless communication environment with associated components that can enable operation of an enterprise network in accordance with aspects described herein.

FIG. 11 illustrates a block diagram of a computer operable to execute or implement all or portions of the disclosed architecture.

FIG. 12 illustrates a schematic block diagram of an exemplary computing environment.

### DETAILED DESCRIPTION

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

As used in this application, the terms “system,” “component,” “engine,” and the like are generally intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. These components also can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. An interface can include input/output (I/O) components as well as associated processor, application, and/or API components.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from by a computing device.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media

Further, terms like “mobile device,” “mobile,” “access terminal,” “terminal,” “handset,” and similar terminology, generally refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “cell site,” “Node B,” “evolved Node B” and other outdoor environment devices, can be utilized interchangeably in the subject application. Similarly, terms such as “femtocell”, “femto,” “home Node B”, “micro cell” and other indoor environment devices can be used interchangeably as well. In either outdoor or indoor cases, such devices can refer to a wireless network component or appliance that serves and receives data, control, voice, video, sound, gaming, or substantially any data-stream or signaling-stream from a set of subscriber mobile devices. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network,” “communications network,” “network” and the like are used interchangeable in the subject application, when context for any of these term utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

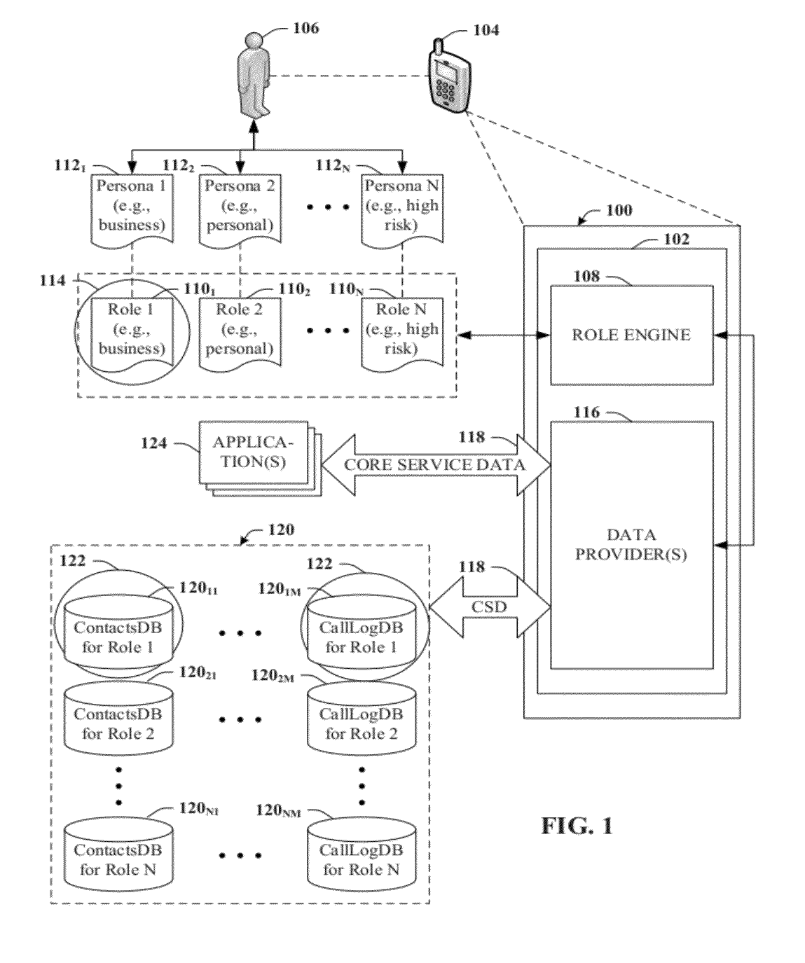

Referring now to the drawing, with reference initially to FIG. 1, system 100 that can provide contextual role awareness is depicted. Generally, system 100 can include operating system 102 that can be embodied in a computer-readable storage medium. It is understood that system 100 and/or operating system 102 can be included in a consumer electronic device 104, such as a smart phone or another mobile device, which can be associated with user 106.

Regardless, operating system 102 can include role engine 108 that can be configured to manage multiple roles 110₁-110_{N} associated with multiple contextual personas 112₁-112_{N}, where N can be any substantially positive integer. Moreover, it should be understood that the multiple roles 110₁-110_{N} and the multiple contextual personas 112₁-112_{N} can be referred to herein, either collectively or individually as role(s) 110 and persona(s) 112, respectively, with appropriate subscripts employed generally only when necessary or convenient to highlight various distinctions or to better impart the disclosed concepts.

In more detail, user 106 can maintain various personas in connection with device 104, for instance, enterprise or business persona 112₁, personal persona 112₂, or high risk persona 112_{N} to illustrate but a few examples. Likewise, role engine 108 can manage associated roles 110, e.g., business role 110₁ (associated with business persona 112₁), personal role 110₂ (associated with personal persona 112₂), high risk role 110_{N} (associated with high risk persona 112_{N}), and so on. Moreover, role engine 108 can be further configured to determine a current role 114. As indicated, in the current example, business role 110₁ is designated current role 114, which is further detailed infra.

In addition, system 100 can also include at least one data provider 116 that can be configured to access core service data 118 from at least one selected database(s) 122, which are illustrated with circles to distinguish selected database(s) 122 from non-selected databases. In particular, selected database(s) 122 can be selected from amongst a set of databases 120₁₁-120_{NM}, where M can be substantially any positive integer, and where databases 120₁₁-120_{NM} can be referred to herein either individually or collectively as database(s) 120 or as set 120. Furthermore, selected database(s) 122 can be selected from the set of databases 120 based upon current role 114.

For example, as depicted in this example, business role 110₁ (e.g., Role 1) is selected as current role 114. As a result, databases 120₁₁-120_{1M}, which are associated with Role 1 and/or business role 110₁, can therefore be designated as selected database(s) 122. Accordingly, as is further detailed below, core service data 118, such as contacts information, call log information, message history information, or the like included in databases 120 can be acquired from the selected database(s) 122 rather than from non-selected databases. Hence, core service data 118 requests from one or more application 124, can be satisfied by data from the selected database(s) 122, which, again, can be selected based upon a determination by role engine 108 of current role 114 and/or determined based a role 110 associated with an application 124 soliciting a request for core service data 118.

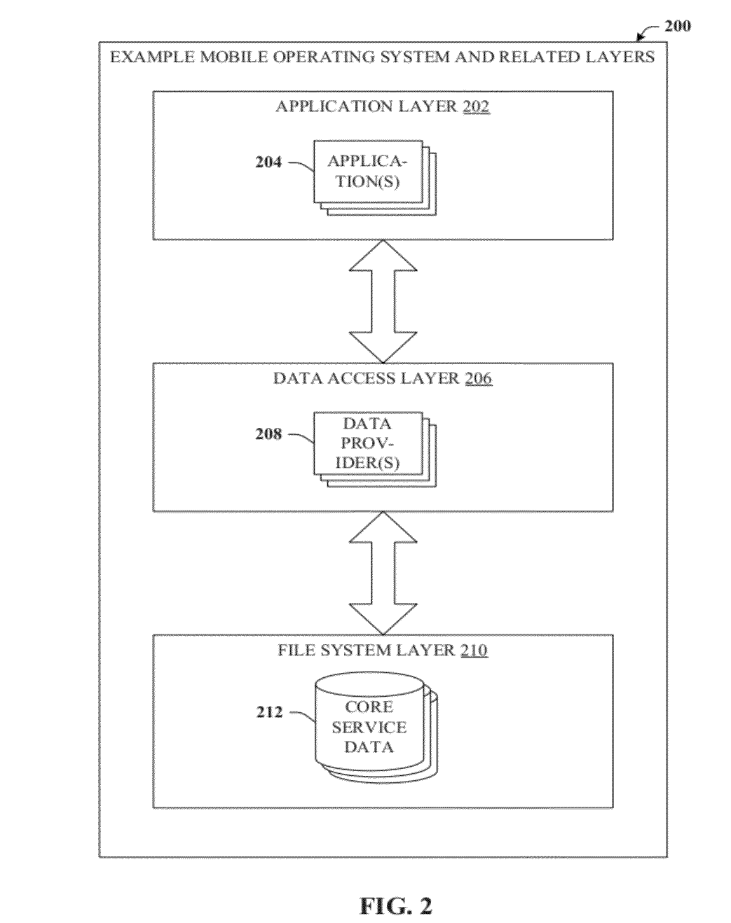

In one or more embodiment, operating system 102 can be a mobile operating system. In particular, the mobile operating system can be configured to provide at least one core service characterized by common application layer access to core service data 118. In other words, application(s) 124 can all access the same core service data 118, or the same sets of core service data 118. Such a feature bears out a fundamental difference between mobile operating systems and desktop-oriented operating systems, which is further described in connection with FIG. 2.

Turning now to FIG. 2, system 200 provides an example mobile operating system and related layers. At the top is application layer 202, which can include all the applications 202 that can be run by the mobile operating system, such as games, telephony applications, and so on. These applications 202 can generate requests for core service data by way of data access layer 206, which can include one or more data provider(s) 208. Based upon the requests, data provider(s) 208 can access file system 210, and in particular, core service data databases 212 to obtain the requested core service data.

Thus, while many observers today tend to view the term “mobile operating system” as an indication of geographic mobility, there are actually technical and fundamental design differences that are not directly related to geographic mobility. Hence, as used herein, the terms “mobile operating system” are generally intended to relate to an operating system that maintains a data access layer with data providers for access to core service data. In terms of design, such is not particularly interesting for desktop-oriented operating systems, but can be for mobile operating systems, in a large portion of the data and features maintained or provided by the host device (e.g., a smart phone) relate to personal-centric data (e.g., contacts) that can be commonly shared by many applications, rather than to application-centric data that is generally proprietary and protected from access by other applications.

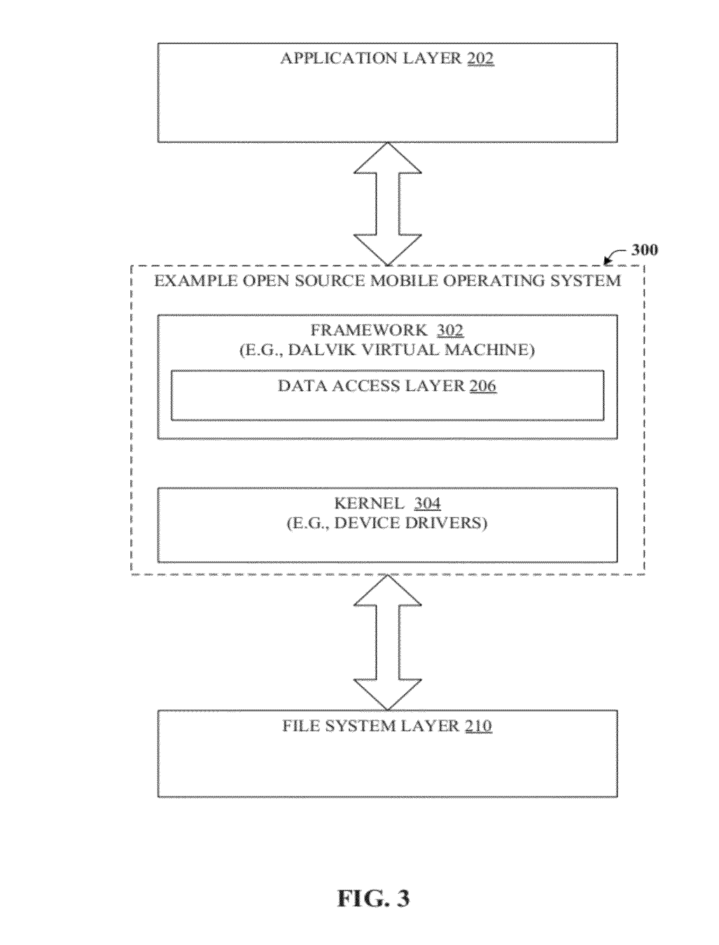

Regardless, in one or more embodiment, operating system 102 can be a mobile operating system configured as an Android-based mobile operating system or another open source-based mobile operating system. With reference now to FIG. 3, system 300 illustrates an example open source mobile operating system. As introduced previously in connection with FIG. 2, system 300 can be associated with or include application layer 202. Likewise, system 300 can be associated with or include file system layer 210.

As depicted by this example open source mobile operating system 300, open source operating systems typically include a framework 302 (which can include data access layer 206) and kernel 304. For Android-based operating systems, framework 302 is typically composed of a Dalvik Virtual Machine (VM). The Dalvik VM can be a register-based architecture or a stack-based architecture, such as a Dalvik Java VM. In either case, framework 302 provides the structure upon which applications (e.g., those in application layer 202) run. Kernel 304 generally includes items such as device drivers that enable hardware to communicate properly with other device hardware or software.

In order to underscore various distinctions with the disclosed subject matter, it should be understood that, generally, most market participants in the mobile device domain operate in the application layer. For example, the vast majority of market players devote their activities to constructing, updating, or maintaining applications to run on devices. A small percentage of market participants, such as device manufacturers, operate in the kernel area (e.g., kernel 302). For instance, a device manufacturer might configure the device drivers for a particular design. However, by and large, framework 302 and file system 210 is largely the same for all market players. Yet, by customizing these areas, something that is absent in the current art, many of the features detailed herein can be provided, which is further detailed infra.

Referring back to FIG. 1, and as detailed previously, operating system 102 can be a mobile operating system configured to provide at least one core service characterized by common application layer access to core service data 118. Thus, multiple applications 124 can share common access to the same core service data 118. In one or more embodiment, the at least one core service can be configured to provide data (e.g., core service data 118) in response to an operating system call by at least one of an email-based application, a contacts-based application, a calendar-based application, a telephony-based application, or a messaging-based application. Hence, these types as well as other suitable types are considered to be exemplary for applications 124.

Likewise, in one or more embodiment, core service data 118 can include at least one of contacts data associated with at least one of the multiple roles 110, address data associated with at least one of the multiple roles 110, message history data associated with at least one of the multiple roles 110, or call log data associated with at least one of the multiple roles 110. It is understood that the above-mentioned examples of applications 124 as well as roles 110 are intended to be concrete, though non-limiting examples.

Moreover, it is understood, in one or more embodiment, set of databases 120 can include at least one distinct database for each of the multiple roles 110. For example, as illustrated, each of the multiple roles 110 can have an associated database 120 or an associated set of databases 120. Thus, a distinct database can exist for contacts, call logs, address data, message history and so forth, and each such database can have counterparts for each registered role 110.

Additionally, in one or more embodiment, multiple contextual persona(s) 112 can be associated with multiple different phone numbers that can be employed by device 104. In accordance therewith, role engine 108 can be further configured to associate the multiple different phone numbers with at least one different role included in multiple roles 110. Hence, core service data 118 actually provided by data provider(s) 116 and/or role 110 selection can be a function of hardware settings as well as various mechanisms operating underneath data provider(s) 116 and/or within data access layer 206 or framework 302.

Furthermore, in one or more embodiment, a first database 120 or set of databases, e.g., 120₁₁-120_{1M} associated with first role 110₁ can include core service data 118 that is encrypted with a first encryption key (e.g., an encryption key assigned to first role 110₁), whereas a second database 120 or set of databases, e.g., 120₂₁-120_{2M} associated with second role 110₂ can include core service data 118 that is encrypted with a second encryption key (e.g., an encryption key associated with second role 110₂). As such, applications 124 can be limited to decrypting core service data 118 only for associated roles 110 in which a particular application 124 is operating.

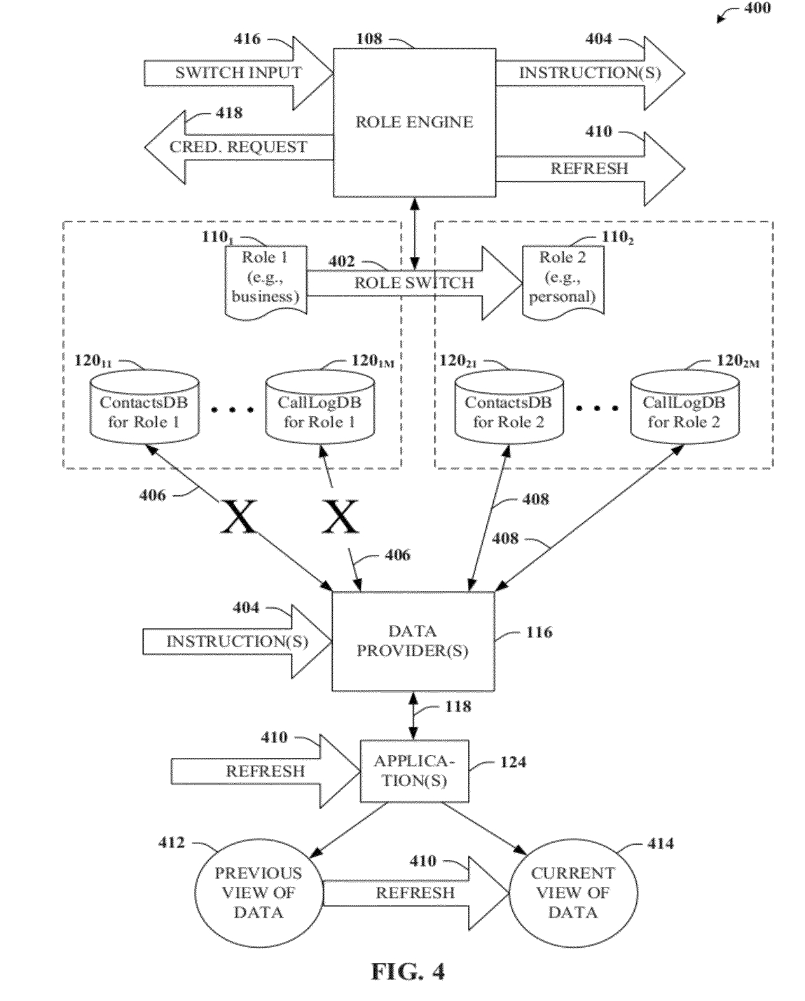

Turning now to FIG. 4, system 400 that can facilitate a role switch in connection with contextual role awareness is provided. In general, system 400 can include role engine 108 and at least one data provider 116, as substantially described above in connection with FIG. 1. In addition to what has been previously detailed, role engine 108 can be further configured to facilitate role switch 402. Role switch 402 can be characterized by a switch from a first role (e.g., business role 110₁) included in multiple roles 110 to a second role (e.g., personal role 110₂) included in multiple roles 110.

Hence, in connection with role switch 402, role engine 108 can be further configured to issue one or more instruction(s) 404 to data provider(s) 116. Instruction 404 can indicate to data provider(s) 116 to terminate access to one or more first database(s) associated with the first role, and to open access to one or more second database(s) associated with the second role. Thus, as depicted, data provider(s) 116 terminates connections 406 to databases 120₁₁-120_{1M}, and opens connections 408 to databases 120₂₁-120_{2M}. It is therefore understood, in this example, that prior to role switch 402, business role 110₁ was current role 114, whereas after role switch 402, personal role 110₂ is designated current role 114. As a result, databases 120₁₁-120_{1M} associated with the first role are deselected, while databases 120₂₁-120_{2M} become selected databases 122.

Additionally, and also in connection with role switch 402, role engine 108 can be further configured to issue one or more refresh command(s) 410. Refresh command(s) 410 can be received by application(s) 124, and can be configured to refresh an application-based view of core service data 118 included in selected database(s) 122 (e.g., databases 120₂₁-120_{2M} associated with the second role). For example, 412 previous view of data can be based upon data included in databases associated with the first role. However, after refreshing, current view of data 414 can include data from databases associated with the second role.

In many cases, standard operating system calls already provide for such functionality. Hence, refresh command(s) 410 can be standard operating system calls. Moreover, while views 412, 414 can certainly be different, it should be appreciated that no change to the application(s) 124 need be required. Thus, the disclosed subject matter can be implemented without requiring substantial changes to existing infrastructure, and in most cases, no changes at all (e.g., existing applications, hardware, etc. can require no changes). Moreover, not only do applications 124 require no changes, in one or more embodiment, role switch 402 does not necessitate a termination or restart of any application 124 or process. Rather, given that role switch 402 can be facilitated by switching databases, a transaction between data provider(s) 116 and databases 120, without otherwise affecting application(s) 124, role switch 402 can seamlessly switch between the first role and the second role from the perspective of applications 124 or the application-based view. Thus, given operating system 102 and/or applications 124 need not be shut down or restarted, role switch 402 can be accomplished in a matter of a few seconds or less.

In addition, in one or more embodiment, role engine 108 can be further configured to facilitate role switch 402 based upon switch request input 416. Switch request input 416 can be input to mobile device 104 or to a user interface thereof. Switching request input 416 can be effectuated by clicking a button or selection of an icon or another object or substantially any suitable gesture input to the mobile device or an associated user interface. For example, shaking the device in a predetermined manner, or physically flipping or rotating the device (e.g., a device equipped with suitable accelerometers or similar), or the like can be employed to initiate role switch 402. Appreciably, a single gesture can be employed to switch back and forth between any two roles (e.g., between business and personal) or to cycle sequentially between roles when more than two roles exist. Additionally or alternatively, the gesture can differ based upon the desired role. In other words, a particular gesture can be employed to switch to the business role (potentially from any other role), whereas a different gesture can be employed to switch to the personal role, and so on.

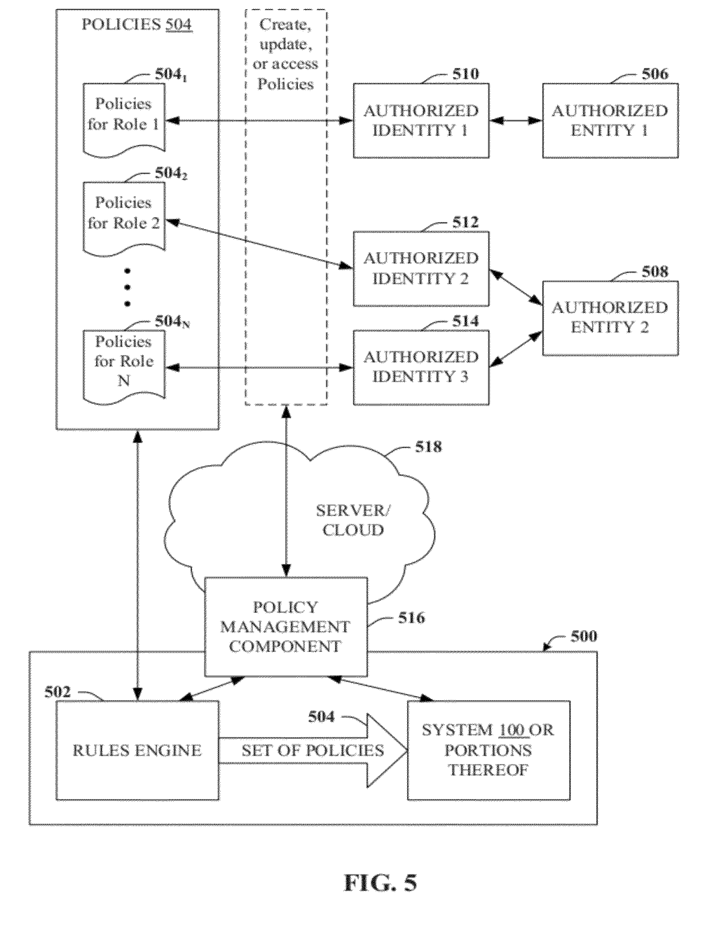

In the current example, role switch 402 represents a switch from a business role to a personal role, however, it is readily understood that role switch 402 could operate in the reverse by switching from a personal role to a business role. Regardless, role engine 108 can be further configured to request input of a password or another credential prior to completion of role switch 402, which is represented here as credential request 418. Credential request 418 will generally be satisfied based upon the current role 114, or the role that is being switched to. Hence, if personal role 110₂ does not require a password, but business role 110₁ does, then role switch 402 from business to personal need not require credential request 418 and/or a concomitant credential input, whereas role switch 402 from personal to business can lead to credential request 418. Thus, as will become more apparent with reference to FIG. 5, the multiple roles 110 can maintain dramatically different individual levels of security (and management), and lax security in one role 110 need not affect the security risk exposure of other roles 110.

Furthermore, in one or more embodiment, role engine 108 can be further configured to enable multiple roles 110 to operate concurrently, which can be characterized by one or more application 124 running in accordance with, e.g., first role 110₁, and the same or a different one or more application 124 running in accordance with, e.g., second role 110₂. For example, consider the case in which a first email application associated with corporate mail is running and syncing mail with an Exchange server, while a second email application associated with a personal mail is running and synching mail with a webmail servicer. Irrespective of current role 114, both applications can be operating concurrently, yet each application can be associated with distinct databases 120 or sets thereof based upon the current role at the time the application was instantiated or is otherwise associated with.

Referring now to FIG. 5, system 500 that can apply and manage policies in connection with operating system-based contextual role awareness is depicted. System 500 can include all or portions of system 100 as well as other components described herein. In addition, system 500 can include rules engine 502 that can be operatively coupled to or included in system 100. Rules engine 502 can be configured to apply a set of policies 504 that can be selected based upon current role 114. Set of policies 504 can relate to predetermined behavior, settings, usage, or restrictions enforced by operating system 102. Thus, e.g., set of policies 504 can define what applications are allowed to be installed or run, can define a blacklist or white list of applications or networks or domains, can define websites that are allowed to be visited or even if a browser is deactivated entirely, can define a type and level of security (e.g., for credential input or requirements related to screenlocks), and so forth. Furthermore, set of policies 504 can also track usage for each of the multiple roles 110, including, e.g., telephony usage, data usage, application usage, and so on.

In one or more embodiment, the set of policies 504 applied by rules engine 502 can be selected from multiple sets of policies 504₁-504_{N}. Thus, each set of policies 504₁-504_{N} can be associated with a different role 110₁-110_{N} included in multiple roles 110. However, it should be understood that not every role 110 need include or be associated with a set of policies 504. Rather, some roles 110 (e.g., high risk role 110_{N}) might have no password requirement or any policies relating to security, whereas other roles 110 (e.g., business role 110₁) almost certainly will.

Moreover, in one or more embodiment, a first set of policies 504₁ from the multiple sets of policies 504 can be accessible only by a first authorized entity 506 and/or a first authorized identity 510, that differs from a second authorized entity 508 and/or a second authorized identity 512 authorized to access a second set of policies 504₂ from the multiple sets of policies 504. Thus, in order to create, update or otherwise access a given set of policies 504, some type of authorization can be required.

To continue with the previous examples, consider again that Role 1 is a business role, Role 2 is a personal role, and Role N is a high risk role. As previously detailed, Role 1 can be associated with a first set of databases 120, that include business data, such as corporate contacts and addresses and the like. Likewise, Role 2 can be associated with databases that store contacts and other data associated with friends and family, whereas Role 3 can be associated with databases include contacts and addresses for rare acquaintances or might include no data at all. For example, the high risk profile might be used only for, say, gaming or other entertainment whereby any application can be downloaded and installed, and unsecure networks and addresses can be surfed at will.

Regardless, Role 1 can be managed by the enterprise issuing mobile device 104 by way of policies 504₁. In other words, the enterprise can be represented by authorized entity 506. Similarly, user 106, represented by authorized entity 508, might manage policies 504₂ and 504_{N} by way of authorized identities 512 and 514, respectively. In this way, user 106 need not have any authority to manage policies 504₁, just as user 106's employer need not have any authority to access or manage policies 504₂-504_{N}.

In such a manner, the difficulties that arise in conventional systems can be avoided or largely mitigated. Namely, a high degree of security need not be achieved by compromising features or functionality. For example, a corporation can be as zealous about security as possible, e.g., disallowing all apps, forbidding all unauthorized network traffic and calls, and requiring very sophisticated credential input at multiple times and at different levels of access. On the other hand, user 106, no matter how restrictive corporate policy may be, need not lose any feature or functionality of the host device. Rather, user 106 can quickly switch roles, e.g., to personal role 110₂ or the like, to complete calls or run applications that are forbidden under the corporate role 110₁. Moreover, if user 106 does engage in high-risk behavior, corporate data need not be exposed. Rather, only personal databases (but not corporate databases) are exposed while in the personal role. In order to again expose corporate data, a role switch 402 typically must be accomplished, after which the device can be once again managed and secure. As a result, enterprise security can actually be superior to what exists today, as even the most stringent of policies are much less likely to cause dissent or resentment from employees who would like to leverage all possible features or functionality.

In accordance with the above, in one or more embodiment, at least one policy from any of the multiple sets of policies 504 can be configurable. In other words, as introduced above, authorized entities can create or update policies 504. Such can be accomplished by policy management component 516 that can be configured to construct or update all or a portion of policies 504. For example, policy management component 516 can provide a user interface or console for constructing and managing policies, as well as verifying authorization. In one or more embodiment, all or portions of policy management component 516 can, as with rules engine 502, be included in device 106 and/or system 100. Additionally or alternatively, all or portions of policy management component 516 can be included in a server 518 or cloud accessible via a local area network or a wide area network. Thus, both user 106 and an associated employer can log into the cloud/server 518 to manage polices 504 with which the subject entity is authorized to manage.

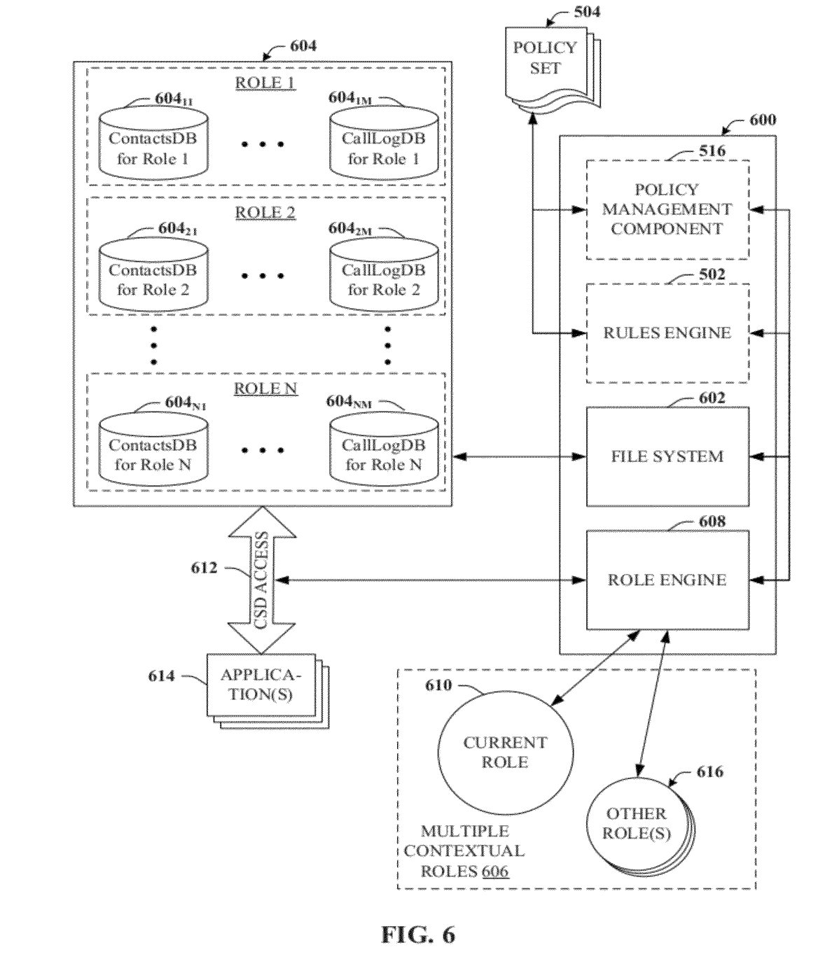

With reference now to FIG. 6, system 600 that can provide multiple data stores for multiple contextual roles is illustrated. System 600 can include file system 602 that can be embodied in a computer-readable storage medium. File system 602 can be configured to maintain at least one database 604₁₁-604_{NM} of core service data for each of multiple contextual roles 606.

In addition, system 600 can further include role engine 608 that can be configured to identify current role 610 out of the multiple contextual roles 606. Moreover, role engine 608 can be further configured to manage access 612 to the at least one database 604₁₁-604_{NM} as a function of current role 610. It is understood that role engine 608 can be substantially similar to role engine 108 of FIGS. 1 and 4, and can therefore include all or a portion of the aspects, embodiments, or features detailed with respect to role engine 108.

For example, role engine 608 can be further configured to identify one or more selected database(s) from among the at least one database 604₁₁-604_{NM}, wherein the selected database is associated with current role 610. Hence, role engine 608 can provide access 612 by one or more application(s) 614 only to the selected database. In addition, role engine 608 can be further configured to initiate a role switch characterized by de-selection of a first database associated with a first role as the selected database, and selection of a second database associated with a second role as the selected database.

In one or more embodiments, role engine 608 can be further configured to facilitate a refresh instruction characterized by a standard operating system call to refresh an application view of core service data, whereby the refresh instruction updates the application view of core service data from core service data included in the first database to core service data included in the second database. Typically, the role switch will be initiated in response to gesture-based input received by a user interface.

Moreover, role engine 608 can be further configured to present to a user interface a request for input of a password or other credential associated with the second role prior to completion of the role switch. Furthermore, system 600 can optionally include rules engine 502 that can be configured to apply a set of policies 504 that can be selected based upon current role 610. The applied set of policies 504 can relate to predetermined behavior, settings, usage, or restrictions, as discussed supra. In addition, system 600 can also optionally include policy management component 516 that can be configured to construct or update one or more of multiple sets of policies 504.

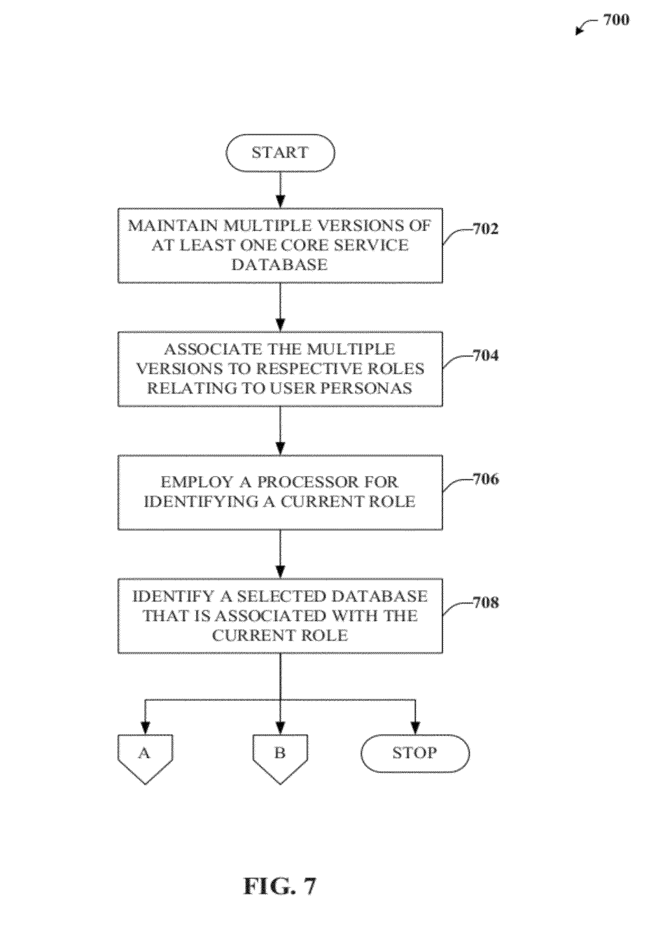

FIGS. 7-9 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers.

Referring now to FIG. 7, exemplary method 700 for providing contextual role awareness for a mobile operating system associated with an electronic device is depicted. Generally, at reference numeral 702, multiple versions of at least one core service database can be maintained. For example, consider that three core service databases are maintained, one for contacts, one for call logs, and one for message history. For each of those three core service databases, multiple versions can exist.

Moreover, at reference numeral 704, the multiple versions of the at least one core service database can be associated with respective roles for the device. For instance, each role can be related to associated personas of a user of the device, e.g., a business role, a personal role, a family role, a bowling league role, a high risk role, and so forth.

Thus, at reference numeral 706, a processor can be employed for identifying a current role. At reference numeral 708, a selected database can be identified and selected from among the at least one core service database associated with the current role. For example, a different core service database (or sets of databases) can be selected depending upon which role is identified as the current role.

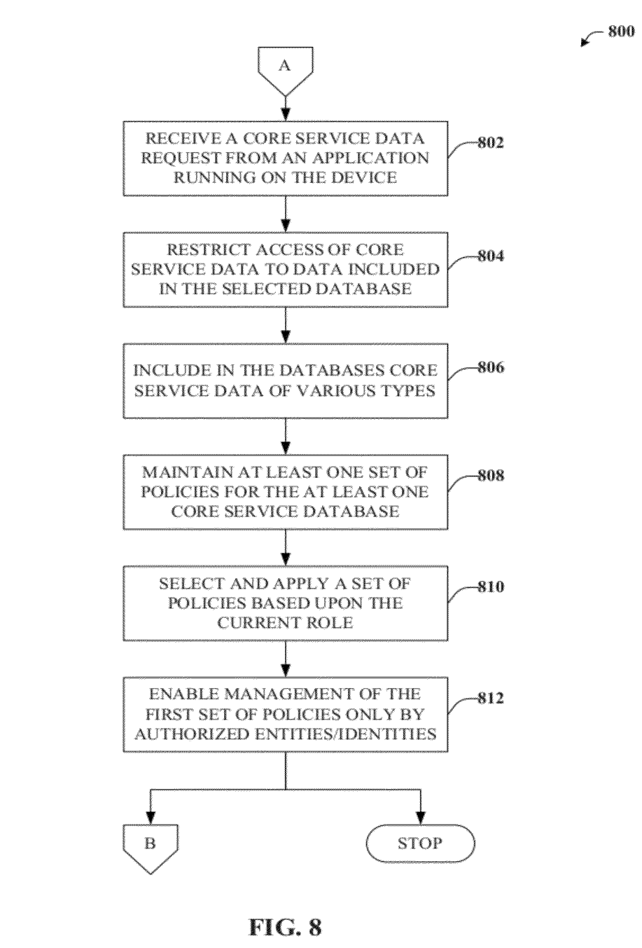

Turning now to FIG. 8, exemplary method 800 for providing additional features or aspects in connection with providing contextual role awareness is illustrated. For example, at reference numeral 802, a core service data request can be received from an application running on the device. The core service data request will typically be a request for core service data, such as contacts data or the like. Thus, at reference numeral 804, access to core service data can be restricted to data included in the selected database or databases.

By way of further illustration, at reference numeral 806, core service data associated with at least one of contacts data, address data, message history data, or call log data can be included in the at least one database. Thus, the core service data request can be satisfied by providing a version of the core service data that is included in the selected database.

Next to be described, at reference numeral 808, at least one set of policies can be maintained for the at least one core service database. For example, a different set of policies can be maintained for each version of the core service database(s). Thus, at reference numeral 810, a particular set of policies from the at least one set of policies can be selected and applied based upon the current role. Accordingly, at reference numeral 812, management of a first set of policies can be enabled only for an associated first authorized entity or identity that differs from a second authorized entity or identity that is authorized to manage a second set of policies.

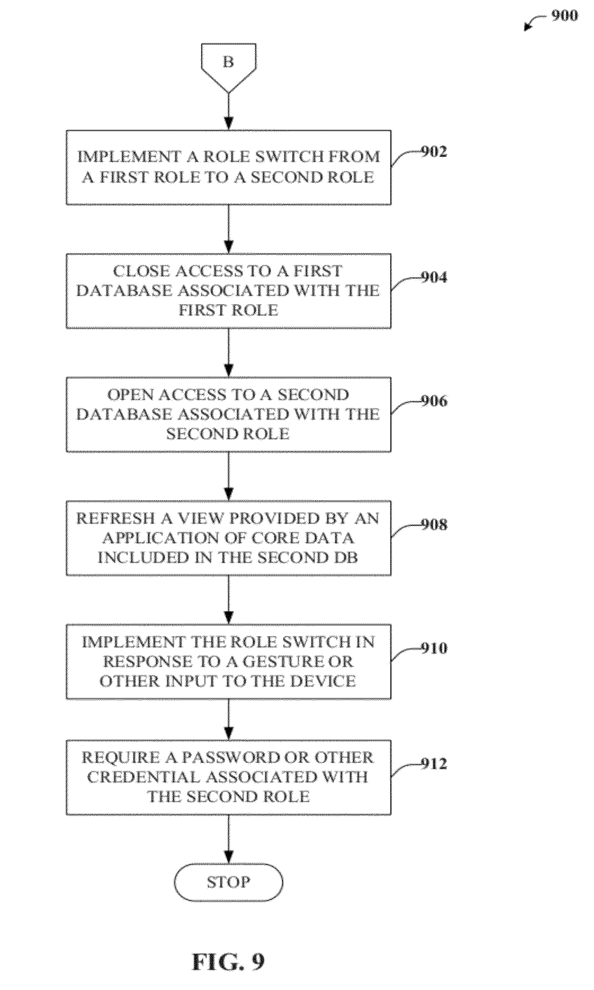

Now regarding FIG. 9, exemplary method 900 for facilitating a role switch between two of the multiple contextual roles is provided. At reference numeral 902, a role switch from a first role to a second role can be implemented. For example, if a device is current set to a business role and a user desires to switch to a personal role, then the role switch can be employed to accomplish such.

Moreover, at reference numeral 904, access to a first database associated with the first role can be closed in connection with the role switch detailed at reference numeral 902. Furthermore, at reference numeral 906, access to a second database associated with the second role can be opened in connection with the role switch. Hence, continuing the example of switching to a personal role from a business role, at reference numerals 904 and 906, access to the databases including a business version of core service data can be closed, while access to the databases including a personal version of the core service data can be opened.

In addition, at reference numeral 908, a view provided by an application of the version of core service data included in the first database (e.g., business data) can be refreshed to a corresponding view of core service data included in the second database (e.g., personal data) in connection with the role switch. Thus, the role switch can be transparent and seamless as far as the application or an associated application-view is concerned, since relevant changes associated with the role switch can occur at a lower level than the application layer. Moreover, the application need not be terminated and/or restarted, which would otherwise require additional time akin to a reboot or restart process.

Furthermore, at reference numeral 910, the role switch can be implemented in response to a gesture or other input to the device. The gesture or other input can be, e.g., a touch or selection of a button or icon or another user interface or I/O object as well as a motion or gesture of the entire device. At reference numeral 912, a password or other credential associated with the second role can be required prior to granting access to the second database. Hence, if switching from a business role to a personal role, then irrespective of the credential requirements required by the business role, access can be defined by the credential requirements of the personal role. Thus, if the personal role does not require a password, then this step can be skipped. Regardless, to switch back again to the business role, then a suitable password, subject to the set of policies assigned to the business role, will typically need to be input.

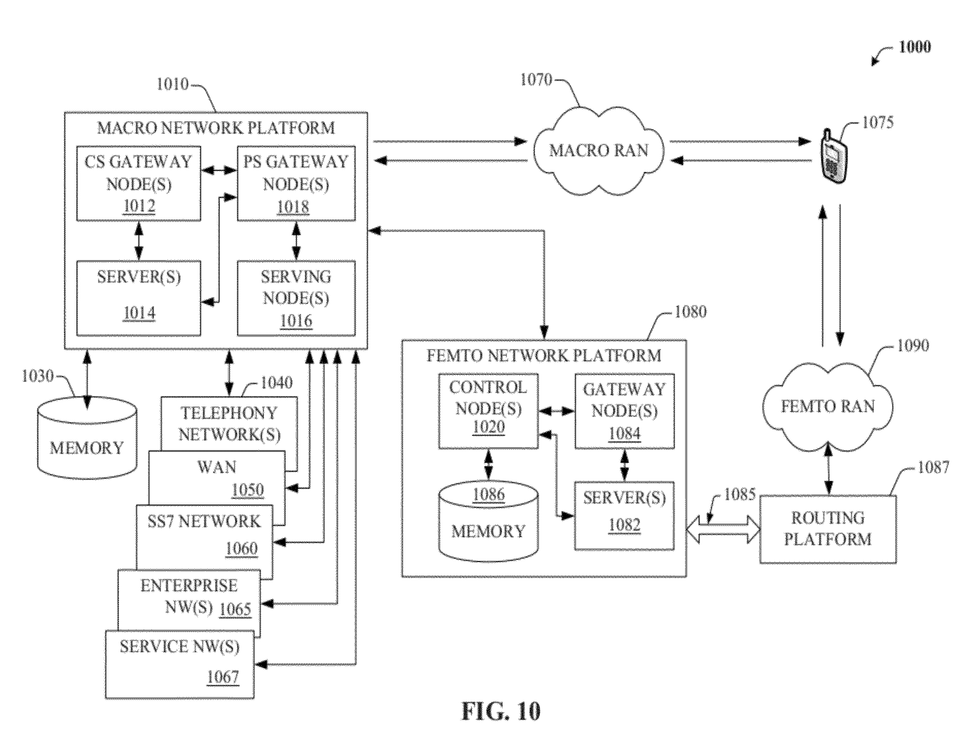

To provide further context for various aspects of the subject specification, FIG. 10 illustrates an example wireless communication environment 1000, with associated components that can enable operation of a femtocell enterprise network in accordance with aspects described herein. Wireless communication environment 1000 includes two wireless network platforms: (i) A macro network platform 1010 that serves, or facilitates communication) with user equipment 1075 via a macro radio access network (RAN) 1070. It should be appreciated that in cellular wireless technologies (e.g., 4G, 3GPP UMTS, HSPA, 3GPP LTE, 3GPP UMB), macro network platform 1010 is embodied in a Core Network. (ii) A femto network platform 1080, which can provide communication with UE 1075 through a femto RAN 1090, linked to the femto network platform 1080 through a routing platform 102 via backhaul pipe(s) 1085. It should be appreciated that femto network platform 1080 typically offloads UE 1075 from macro network, once UE 1075 attaches (e.g., through macro-to-femto handover, or via a scan of channel resources in idle mode) to femto RAN.

It is noted that RAN includes base station(s), or access point(s), and its associated electronic circuitry and deployment site(s), in addition to a wireless radio link operated in accordance with the base station(s). Accordingly, macro RAN 1070 can comprise various coverage cells like cell 1105, while femto RAN 1090 can comprise multiple femto access points. As mentioned above, it is to be appreciated that deployment density in femto RAN 1090 is substantially higher than in macro RAN 1070.

Generally, both macro and femto network platforms 1010 and 1080 include components, e.g., nodes, gateways, interfaces, servers, or platforms, that facilitate both packet-switched (PS) (e.g., internet protocol (IP), frame relay, asynchronous transfer mode (ATM)) and circuit-switched (CS) traffic (e.g., voice and data) and control generation for networked wireless communication. In an aspect of the subject innovation, macro network platform 1010 includes CS gateway node(s) 1012 which can interface CS traffic received from legacy networks like telephony network(s) 1040 (e.g., public switched telephone network (PSTN), or public land mobile network (PLMN)) or a SS7 network 1060. Circuit switched gateway 1012 can authorize and authenticate traffic (e.g., voice) arising from such networks. Additionally, CS gateway 1012 can access mobility, or roaming, data generated through SS7 network 1060; for instance, mobility data stored in a VLR, which can reside in memory 1030. Moreover, CS gateway node(s) 1012 interfaces CS-based traffic and signaling and gateway node(s) 1018. As an example, in a 3GPP UMTS network, gateway node(s) 1018 can be embodied in gateway GPRS support node(s) (GGSN).

In addition to receiving and processing CS-switched traffic and signaling, gateway node(s) 1018 can authorize and authenticate PS-based data sessions with served (e.g., through macro RAN) wireless devices. Data sessions can include traffic exchange with networks external to the macro network platform 1010, like wide area network(s) (WANs) 1050; it should be appreciated that local area network(s) (LANs) can also be interfaced with macro network platform 1010 through gateway node(s) 1018. Gateway node(s) 1018 generates packet data contexts when a data session is established. To that end, in an aspect, gateway node(s) 1018 can include a tunnel interface (e.g., tunnel termination gateway (TTG) in 3GPP UMTS network(s); not shown) which can facilitate packetized communication with disparate wireless network(s), such as Wi-Fi networks. It should be further appreciated that the packetized communication can include multiple flows that can be generated through server(s) 1014. It is to be noted that in 3GPP UMTS network(s), gateway node(s) 1018 (e.g., GGSN) and tunnel interface (e.g., TTG) comprise a packet data gateway (PDG).

Macro network platform 1010 also includes serving node(s) 1016 that convey the various packetized flows of information or data streams, received through gateway node(s) 1018. As an example, in a 3GPP UMTS network, serving node(s) can be embodied in serving GPRS support node(s) (SGSN).

As indicated above, server(s) 1014 in macro network platform 1010 can execute numerous applications (e.g., location services, online gaming, wireless banking, wireless device management . . . ) that generate multiple disparate packetized data streams or flows, and manage (e.g., schedule, queue, format . . . ) such flows. Such application(s), for example can include add-on features to standard services provided by macro network platform 1010. Data streams can be conveyed to gateway node(s) 1018 for authorization/authentication and initiation of a data session, and to serving node(s) 1016 for communication thereafter. Server(s) 1014 can also effect security (e.g., implement one or more firewalls) of macro network platform 1010 to ensure network's operation and data integrity in addition to authorization and authentication procedures that CS gateway node(s) 1012 and gateway node(s) 1018 can enact. Moreover, server(s) 1014 can provision services from external network(s), e.g., WAN 1050, or Global Positioning System (GPS) network(s) (not shown). It is to be noted that server(s) 1014 can include one or more processor configured to confer at least in part the functionality of macro network platform 1010. To that end, the one or more processor can execute code instructions stored in memory 1030, for example.

In example wireless environment 1000, memory 1030 stores information related to operation of macro network platform 1010. Information can include business data associated with subscribers; market plans and strategies, e.g., promotional campaigns, business partnerships; operational data for mobile devices served through macro network platform; service and privacy policies; end-user service logs for law enforcement; and so forth. Memory 1030 can also store information from at least one of telephony network(s) 1040, WAN(s) 1050, or SS7 network 1060, enterprise NW(s) 1065, or service NW(s) 1067.

Femto gateway node(s) 1084 have substantially the same functionality as PS gateway node(s) 1018. Additionally, femto gateway node(s) 1084 can also include substantially all functionality of serving node(s) 1016. In an aspect, femto gateway node(s) 1084 facilitates handover resolution, e.g., assessment and execution. Further, control node(s) 1020 can receive handover requests and relay them to a handover component (not shown) via gateway node(s) 1084. According to an aspect, control node(s) 1020 can support RNC capabilities.

Server(s) 1082 have substantially the same functionality as described in connection with server(s) 1014. In an aspect, server(s) 1082 can execute multiple application(s) that provide service (e.g., voice and data) to wireless devices served through femto RAN 1090. Server(s) 1082 can also provide security features to femto network platform. In addition, server(s) 1082 can manage (e.g., schedule, queue, format . . . ) substantially all packetized flows (e.g., IP-based, frame relay-based, ATM-based) it generates in addition to data received from macro network platform 1010. It is to be noted that server(s) 1082 can include one or more processor configured to confer at least in part the functionality of macro network platform 1010. To that end, the one or more processor can execute code instructions stored in memory 1086, for example.

Memory 1086 can include information relevant to operation of the various components of femto network platform 1080. For example operational information that can be stored in memory 1086 can comprise, but is not limited to, subscriber information; contracted services; maintenance and service records; femto cell configuration (e.g., devices served through femto RAN 1090; access control lists, or white lists); service policies and specifications; privacy policies; add-on features; and so forth.

It is noted that femto network platform 1080 and macro network platform 1010 can be functionally connected through one or more reference link(s) or reference interface(s). In addition, femto network platform 1080 can be functionally coupled directly (not illustrated) to one or more of external network(s) 1040, 1050, 1060, 1065 or 1067. Reference link(s) or interface(s) can functionally link at least one of gateway node(s) 1084 or server(s) 1086 to the one or more external networks 1040, 1050, 1060, 1065 or 1067.

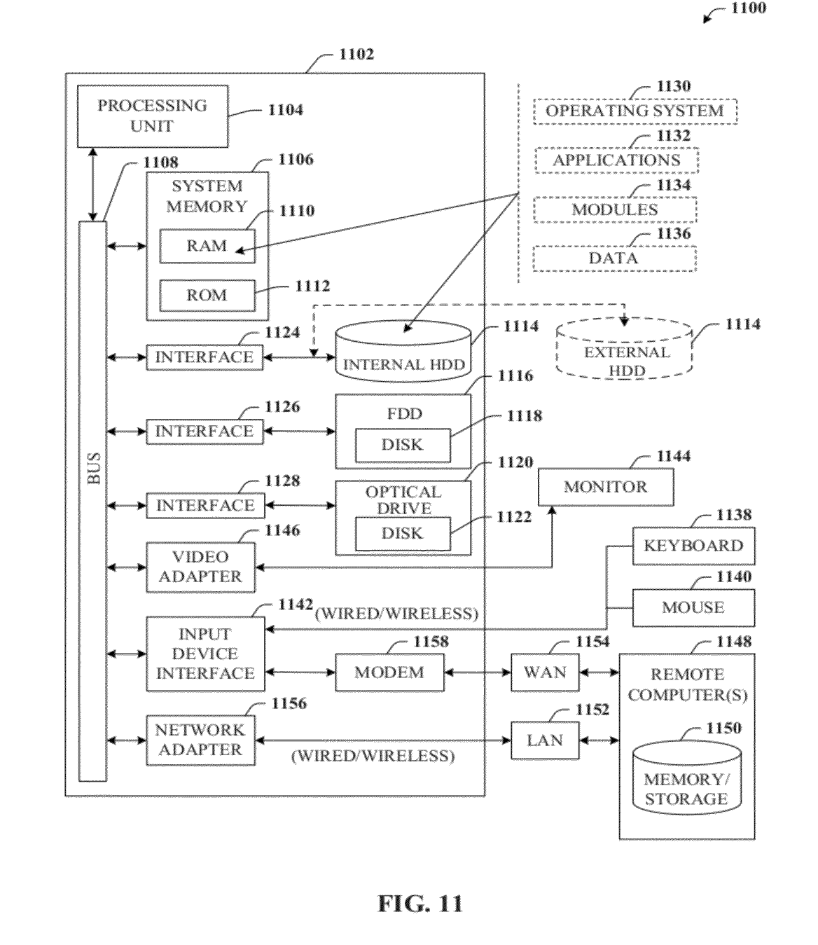

Referring now to FIG. 11, there is illustrated a block diagram of an exemplary computer system operable to execute one or more disclosed architecture. In order to provide additional context for various aspects of the disclosed subject matter, FIG. 11 and the following discussion are intended to provide a brief, general description of a suitable computing environment 1100 in which the various aspects of the disclosed subject matter can be implemented. Additionally, while the disclosed subject matter described above may be suitable for application in the general context of computer-executable instructions that may run on one or more computers, those skilled in the art will recognize that the disclosed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the disclosed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include either volatile or nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1100 for implementing various aspects of the disclosed subject matter includes a computer 1102, the computer 1102 including a processing unit 1104, a system memory 1106 and a system bus 1108. The system bus 1108 couples to system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE1394 interface technologies. Other external drive connection technologies are within contemplation of the subject matter disclosed herein.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the disclosed subject matter can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, a mobile device, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11(a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at 5.5-11 Mbps (802.11b) or 54 Mbps (802.11a) data rate, for example, or with products that contain both bands (dual band), so the networks can provide real-world performance similar to the basic “10BaseT” wired Ethernet networks used in many offices.

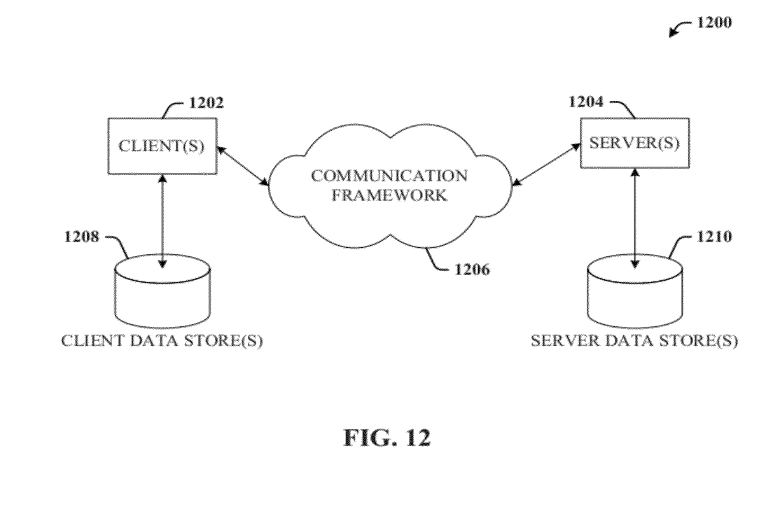

Referring now to FIG. 12, there is illustrated a schematic block diagram of an exemplary computer compilation system operable to execute the disclosed architecture. The system 1200 includes one or more client(s) 1202. The client(s) 1202 can be hardware and/or software (e.g., threads, processes, computing devices). The client(s) 1202 can house cookie(s) and/or associated contextual information by employing one or more embodiments described herein, for example.

The system 1200 also includes one or more server(s) 1204. The server(s) 1204 can also be hardware and/or software (e.g., threads, processes, computing devices). The servers 1204 can house threads to perform transformations by employing one or more embodiments, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

Various aspects or features described herein can be implemented as a method, apparatus, or article of manufacture using standard programming and/or engineering techniques. In addition, various aspects disclosed in the subject specification can also be implemented through program modules stored in a memory and executed by a processor, or other combination of hardware and software, or hardware and firmware. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disc (CD), digital versatile disc (DVD), blu-ray disc (BD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the internet or a local area network (LAN). Of course, those skilled in the art will recognize many modifications may be made to this configuration without departing from the scope or spirit of the disclosed subject matter.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that provides contextual role awareness, comprising:
an operating system in a computer-readable storage medium, comprising:
a role engine configured to manage multiple roles associated with multiple contextual personas and further configured to determine a current role; and
at least one data provider configured to provide access to core service data from at least one selected database selected from amongst a set of databases based upon the current role.

2. The system of claim 1, wherein the operating system is a mobile operating system configured to provide at least one core service characterized by common application layer access to core service data.

3. The system of claim 2, wherein the mobile operating system is an Android-based mobile operating system or another open source-based mobile operating system.

4. The system of claim 2, wherein the at least one core service is configured to provide data in response to an operating system call by at least one of an email-based application, a contacts-based application, a calendar-based application, a telephony-based application, or a messaging-based application.

5. The system of claim 1, wherein the core service data includes at least one of contacts data associated with at least one of the multiple roles, address data associated with at least one of the multiple roles, message history data associated with at least one of the multiple roles, or call log data associated with at least one of the multiple roles.

6. The system of claim 1, wherein the multiple contextual personas are associated with multiple different phone numbers, and the role engine is further configured to associated the multiple different phone numbers with at least one different role included in the multiple roles.

7. The system of claim 1, wherein the set of databases includes at least one distinct database for each of the multiple roles.

8. The system of claim 7, wherein a first database from the at least one distinct database is encrypted with a first encryption key associated with a first role and a second database from the at least one distinct database is encrypted with a second encryption key associated with a second role.

9. The system of claim 1, wherein the role engine is further configured to facilitate a role switch characterized by a switch from a first role included in the multiple roles to a second role included in the multiple roles.

10. The system of claim 9, wherein the role engine is further configured to issue, in connection with the role switch, one or more instruction(s) to the at least one data provider to terminate access to a first database associated with the first role and to open access to a second database associated with the second role.

11. The system of claim 9, wherein the role engine is further configured to issue, in connection with the role switch, one or more refresh command(s) configured to refresh an application-based view of the core service data included in the at least one selected database associated with the second role.

12. The system of claim 11, wherein the one or more refresh command(s) is a standard operating system call.

13. The system of claim 11, wherein the role switch does not necessitate a termination or a restart of an active application or process.

14. The system of claim 11, wherein the role switch seamlessly switches between the first role and the second role from the perspective of the application-based view.

15. The system of claim 9, wherein the role engine is further configured to facilitate the role switch based upon switch request input.

16. The system of claim 15, wherein the switch request input is a gesture received by a user interface associated with the operating system.

17. The system of claim 9, wherein the role engine is further configured to request input of a password or another credential prior to completion of the role switch.

18. The system of claim 9, wherein the role engine is further configured to enable multiple roles to operate concurrently characterized by one or more application running in accordance with a first role and one or more application running in accordance with a second role.

19. The system of claim 1, further comprising a rules engine configured to apply a set of policies selected based upon the current role, wherein the set of policies relate to predetermined behavior, settings, usage, or restrictions enforced by the operating system.

20. The system of claim 19, wherein the set of policies is selected from multiple sets of policies, wherein each set of policies from the multiple sets is associated with a different role included in the multiple roles.

21. The system of claim 20, wherein a first set of policies from the multiple sets is accessible only by a first authorized entity that differs from a second authorized entity authorized to access a second set of policies from the multiple sets.

22. The system of claim 19, wherein at least one policy from the set of policies is configurable.

23. The system of claim 19, further comprising a policies management component configured to construct or update the set of policies.

24. The system of claim 23, wherein the policies management component is included in a server and accessible via a wide area network.

25. The system of claim 1, wherein the multiple roles includes a business role associated with a business persona and a personal role associated with a personal persona.

26. A system that provides multiple data stores for multiple contextual roles, comprising:
a file system, in a computer-readable storage medium, configured to maintain at least one database of core service data for each of multiple contextual roles; and
a role engine configured to identify a current role out of the multiple contextual roles, and further configured to manage access to the at least one database as a function of the current role.

27. The system of claim 26, wherein the role engine is further configured to identify a selected database associated with the current role and to provide access by one or more application(s) operating in connection with the current role only to the selected database.

28. The system of claim 27, wherein the core service data included in the at least one database is encrypted according to a multiple encryption keys, wherein the multiple encryption keys are respectively associated with the multiple contextual roles.

29. The system of claim 27, wherein the role engine is further configured to initiate a role switch characterized by de-selection of a first database associated with a first role as the selected database, and selection of a second database associated with a second role as the selected database.

30. The system of claim 29, wherein the role engine is further configured to facilitate a refresh instruction characterized by a standard operating system call to refresh an application view of core service data, whereby the refresh instruction updates the application view of core service data from core service data included in the first database to core service data included in the second database.

31. The system of claim 29, wherein the role engine is further configured to initiate the role switch in response to a gesture-based input received by a user interface.

32. The system of claim 29, wherein the role engine is further configured to present to a user interface a request for input of a password or other credential associated with the second role prior to completion of the role switch.

33. The system of claim 29, wherein the role engine is further configured to enable multiple roles to operate contemporaneously characterized by one or more application running in accordance with a first role and one or more application running in accordance with a second role.

34. The system of claim 26, further comprising a rules engine configured to apply a set of policies selected based upon the current role, wherein the set of policies relate to predetermined behavior, settings, usage or restrictions.

35. The system of claim 26, further comprising a policies management component configured to construct or update the set of policies.

36. A method for providing contextual role awareness for a mobile operating system associated with an electronic device, comprising:
maintaining multiple versions of at least one core service database;
associating the multiple versions of the at least one core service database to respective roles for the device relating to associated personas of a user of the device;
employing a processor for identifying a current role; and
identifying a selected database from among the at least one core service database associated with the current role.

37. The method of claim 36, further comprising at least one of the following acts:
receiving a core service data request from an application running on the device;
restricting access of core service data to data included in the selected database;
including in the at least one core service database core service data associated with at least one of contacts data, address data, message history data, or call log data;
maintaining at least one set of policies for the at least one core service database;
selecting and applying a set of policies from the at least one set of policies based upon the current role; or
enabling management of a first set of policies only by an associated first authorized entity or identity that differs from a second authorized entity or identity authorized to manage a second set of policies.

38. The method of claim 36, further comprising at least one of the following acts:
implementing a role switch from a first role to a second role;
closing access to a first database associated with the first role in connection with the role switch;
opening access to a second database associated with the second role in connection with the role switch;
refreshing a view provided by an application of core service data included in the first database to a corresponding view of core service data included in the second database in connection with the role switch;
implementing the role switch in response to a gesture or other input to the device; or
requiring a password or other credential associated with the second role prior to granting access to the second database.
